(19) United States
(12) Patent Application Publication
(10) Pub. No.: US 2006/0086778 A1
(43) Pub. Date: Apr. 27, 2006

(54) Postcard for guided fastening of photographs

(76) Inventor: Matthew F. Willson, Austin, TX (US)

Correspondence Address: FORTKORT GRETHER + KELTON LLP, 9442 N. Capital of Texas Hwy., Suite 500, AUSTIN, TX, 78759, US

(21) Appl. No.: 10/974,586

(22) Filed: Oct. 27, 2004

(51) Int. Cl. B42D 15/00; A47G 1/06

(52) U.S. Cl. 229/92.8; 40/773

(57) ABSTRACT

Provided is a postcard (100) including a fastening surface (102) and a guide (106) disposed along an edge of the fastening surface. The guide is configured to limit, by contact and in at least one dimension, the orientation of a photograph relative to the fastening surface. Also provided is a method of manufacturing a postcard (100). A cardstock having a fastening surface (102) is provided. A guide (106) is disposed along an edge of the fastening surface. The guide is raised relative to the fastening surface for constraining lateral movement of a photograph, by contact and in at least one dimension.

### TECHNICAL FIELD OF THE DISCLOSURE

This disclosure pertains to postcards, and, in particular, to postcards configured for fastening of photographs thereto.

### BACKGROUND OF THE DISCLOSURE

A large market exists for preprinted photograph postcards. While the images on such postcards often depict scenes associated with the establishment, city, or state of sale, they can and do vary widely. A drawback of such preprinted photograph postcards is that by their nature they require an individual to select from a predetermined set of photographic images. They are not configured to provide for the fastening of photographs thereto. This prevents individuals from fastening their own photographs to postcards for mailing.

Several approaches have been taken to provide postcards configured to accept the fastening of an individual's photograph thereto. One such approach provides a stiff postcard cardstock with an adhesive surface. The adhesive surface is meant to fasten a clear plastic sheet to the cardstock with an individual's photograph oriented, and hence fastened, therebetween. The opposite surface of the postcard is available for bearing postage, address information, and other indicia required for mailing.

Another approach provides for a hinged postcard having two panels. The interior surface of the first panel includes an adhesive region initially covered by a paper release sheet, which sheet is removable to expose the adhesive region for fastening an individual's photograph thereto. The second panel includes a rectangular opening. Accordingly, when a photograph is fastened to the interior surface of the first panel and the hinged postcard is closed, the photograph is visible through the opening.

As a visual aid to the individual in fastening his photograph, rectangular lines are drawn upon the interior surface of the hinged postcard in concentric alignment with the opening. However, the aid is purely visual, and does not include a structural element for assisting the individual in fastening the photograph to the postcard in a specific desired orientation. The exterior surface of the first panel includes space for postage, address information, and any other indicia.

Yet another approach provides a postcard with a rectangular adhesive region on one of its surfaces, the opposite surface having space for postage, address information, and other mailing indicia. However, this approach lacks a mechanism which would aid an individual in fastening a photograph to the adhesive region with a particular desired orientation.

A need which remains unmet is for a postcard configured for fastening of a photograph thereto and including a structural mechanism for guiding an individual in fastening the photograph to the postcard in a specific desired orientation. This disclosure provides such a postcard. These and other advantages, as well as additional inventive features, will be apparent from the present disclosure.

### BRIEF DESCRIPTION OF THE DRAWINGS

For a more complete understanding of the present disclosure, and the advantages thereof, reference is now made to the following brief descriptions taken in conjunction with the accompanying drawings, in which like reference numerals indicate like features.

FIG. 1 depicts a perspective view of a postcard, in accordance with an embodiment of the present invention.

FIG. 2 depicts a perspective view of another postcard having an alternate adhesive region on its fastening surface, in accordance with an embodiment of the present invention.

FIG. 3 depicts a top view of yet another postcard having another alternate adhesive region on its fastening surface, in accordance with an embodiment of the present invention.

FIG. 4 depicts a top view of a further postcard having yet another alternate adhesive region on its fastening surface, in accordance with an embodiment of the present invention.

FIG. 5 depicts a top view of a still further postcard having a further alternate adhesive region on its fastening surface, in accordance with an embodiment of the present invention.

FIG. 6 depicts a side view of a portion of a postcard having a guide with a greater thickness than the anticipated thickness of a postcard to be fastened thereto, in accordance with an embodiment of the present invention.

FIG. 7 depicts a side view of a portion of a postcard having a guide with the same thickness as the anticipated thickness of a postcard to be fastened thereto, in accordance with an embodiment of the present invention.

FIG. 8 depicts a side view of a portion of a postcard having a guide with a lesser thickness than the anticipated thickness of a postcard to be fastened thereto, in accordance with an embodiment of the present invention.

FIG. 9 depicts a perspective view of still another alternate postcard having two guides rather than one, in accordance with an embodiment of the present invention.

FIG. 10 depicts a perspective view of another alternate postcard, in accordance with an embodiment of the present invention.

### DETAILED DESCRIPTION

This disclosure provides a postcard configured for fastening of a photograph thereto and including a structural mechanism for guiding an individual in fastening the photograph to the postcard in a specific desired orientation.

In particular, this disclosure provides a postcard including a fastening surface and a guide disposed along an edge of the fastening surface. The guide is configured to limit, by contact and in at least one dimension, the orientation of a photograph relative to the fastening surface. An adhesive region can be disposed on the fastening surface for adhesively retaining such a photograph upon contact of a surface of the photograph with the adhesive region. The adhesive region can be disposed on the fastening surface so as to leave a non-adhesive region adjacent to the guide.

An alternate adhesive region is disposed on the fastening surface so that a non-adhesive region is contained within the adhesive region. Another alternate includes at least one additional adhesive region disposed on the fastening surface. At least two of the adhesive regions can be disposed on the fastening surface such that each is oriented along an opposite edge of the fastening surface.

The guide can possess a thickness greater than, equal to, or less than the anticipated thickness of a photograph to be fastened to the postcard.

Furthermore, a paper release sheet can be hingedly attached to the guide for protecting the adhesive region from unintended adhesion. In addition, an additional guide can be disposed along another edge of the fastening surface.

The present disclosure further provides a postcard product including a first layer and a second layer disposed upon the first layer. The second layer includes a guide region oriented along an edge of the second layer and a postcard region adjacent to and hingedly connected to the guide region structurally forming a guide, wherein the postcard region includes a fastening surface between the second layer and the first layer. As a result, the guide is configured to assist an individual in selectively orienting a photograph between the hingedly open postcard region and the first layer, according to which an edge of the photograph can be placed in contact with the guide prior to fastening the photograph to the fastening surface.

Alternately, an adhesive region can be disposed on the fastening surface for adhesively retaining the photograph upon contact of a surface of the photograph with the adhesive region. As another alternative, the adhesive region can be disposed on the fastening surface so as to leave a non-adhesive region adjacent to the guide. Further, at least one additional adhesive region can be disposed on the fastening surface. As another alternative, the first layer can be a paper release sheet for protecting the adhesive region from unintended adhesion. Moreover, the second layer can include an additional guide region disposed along another edge of the second layer.

The present disclosure also provides a method of manufacturing a postcard. A cardstock having a fastening surface is provided. A guide is disposed along an edge of the fastening surface. The guide is raised relative to the fastening surface for constraining lateral movement of a photograph, by contact and in at least one dimension. An adhesive compound can be disposed upon the fastening surface such that at least one adhesive region is formed. A paper release sheet can be disposed upon the adhesive region, and at least one edge of the paper release sheet can be attached to the guide so that, as a result, the paper release sheet is hingedly attached to the guide.

Additional adhesive compound can be disposed upon the fastening surface such that at least one additional adhesive region is formed. The guide can have a thickness greater than, equal to, or less than the anticipated thickness of a photograph to be disposed thereto. As another variant, an additional guide can be disposed along another edge of the fastening surface.

Other aspects, objectives and advantages of the invention will become more apparent from the remainder of the detailed description when taken in conjunction with the accompanying drawings.

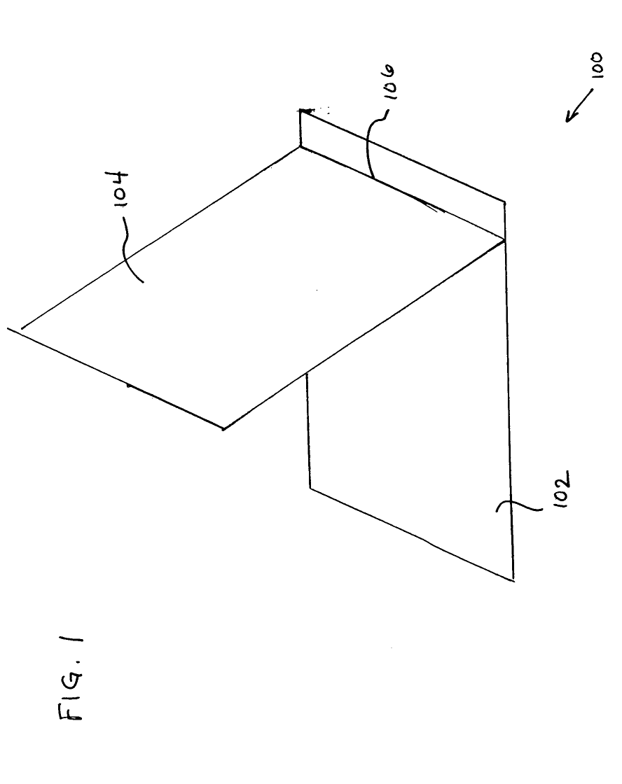

FIG. 1 depicts a perspective view of a postcard 100, in accordance with an embodiment of the present invention. The postcard 100 includes a fastening surface 102 to which an individual may fasten a photograph. The fastening surface 102 is preferably adhesive; therefore a paper release sheet 104 covers the preferably adhesive fastening surface 102 prior to use to prevent undesired fastening of the surface 102. The paper release sheet 104 can be peeled from the preferably adhesive fastening surface in a hinged fashion, creating a guide 106 along the resulting crease. The guide 106 allows an individual to controllably place and orient a photograph by bringing a single edge of the photograph into contact with the guide 106 prior to bringing the back surface of the photograph into contact with the fastening surface 102. Once the individual has contacted the single edge of the photograph to the guide 106, the individual brings the back surface of the photograph into contact with the fastening surface 102, thereby fastening the photograph to the postcard 100. As a result, the fastened photograph has a desired placement and orientation relative to the postcard 100.

The hinge associated with guide 106 may be defined by any mechanism (e.g., perforation, creasing, printed indicia, etc.) which defines the line between the guide 106 and the paper release sheet 104.

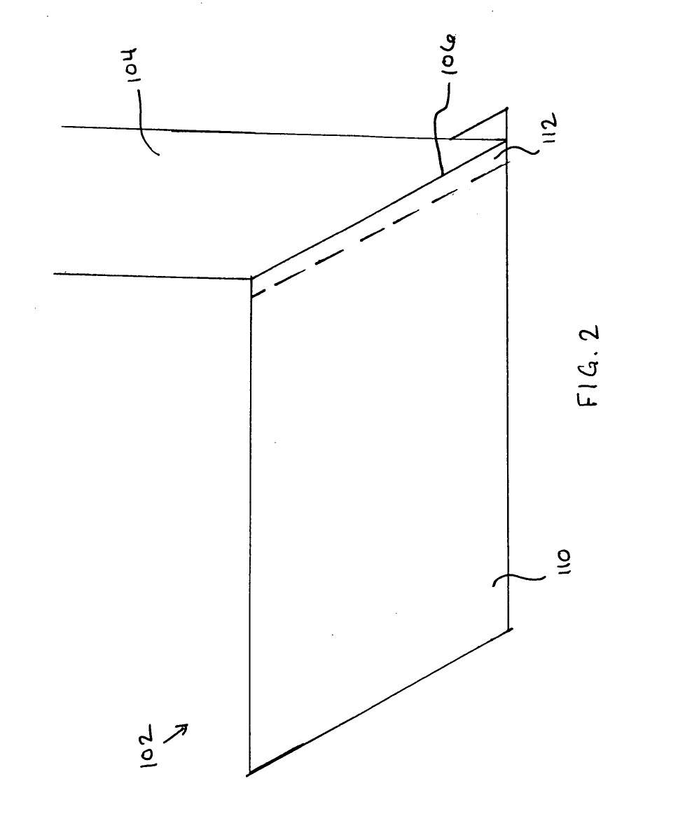

FIG. 2 depicts a perspective view of another postcard having an alternate adhesive region on its fastening surface, in accordance with an embodiment of the present invention. The fastening surface includes an adhesive region 110 and a non-adhesive region 112. The non-adhesive region is adjacent to the guide 106 to provide an individual with the opportunity to move a photograph laterally relative to the guide 106 subsequent to contact of a single edge of the photograph with the guide 106 and prior to contact of the back surface of the photograph with the adhesive region 110 of the fastening surface 102. Once the individual achieves a desired lateral orientation of the photograph relative to the guide 106, the individual brings the back of the photograph into contact with the adhesive region 110, thereby fastening the photograph to the postcard.

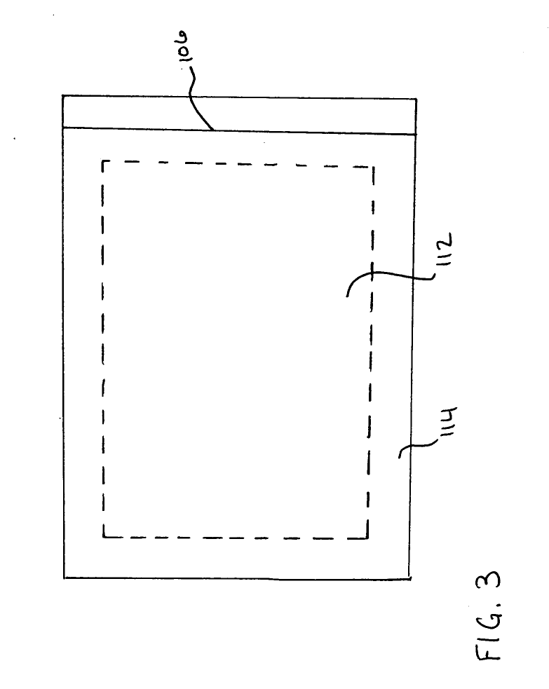

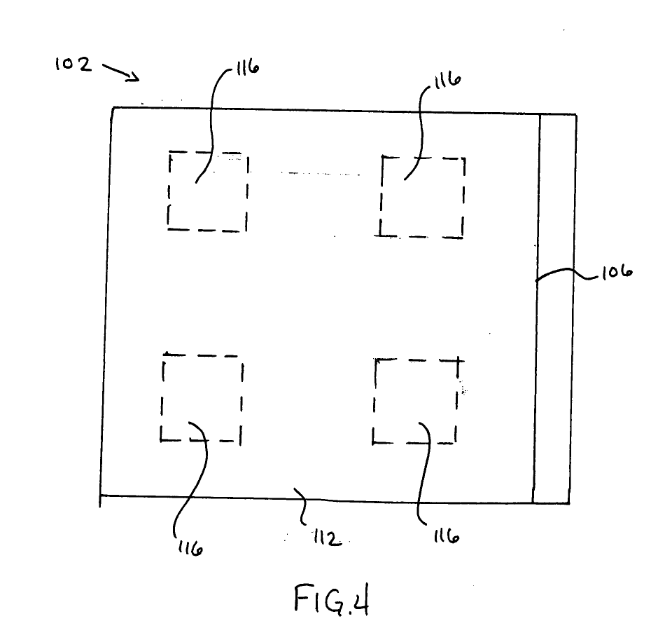

FIGS. 3-5 depict top views of other postcards having other alternate adhesive regions on their fastening surfaces, in accordance with embodiments of the present invention. In the first embodiment, the adhesive region 114 is distributed upon the fastening surface 102 so as to contain within its bounds a non-adhesive region 112. In the second embodiment, four adhesive regions 116 are distributed across the fastening surface 102. In the third embodiment, two elongated adhesive regions 118 are oriented along opposite ends of the fastening surface 102.

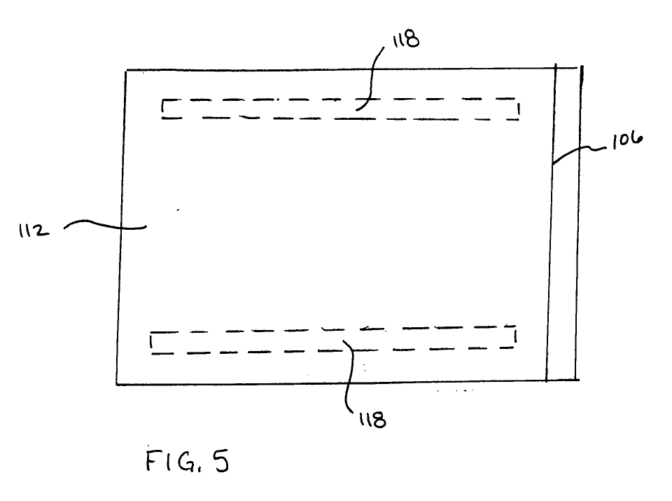

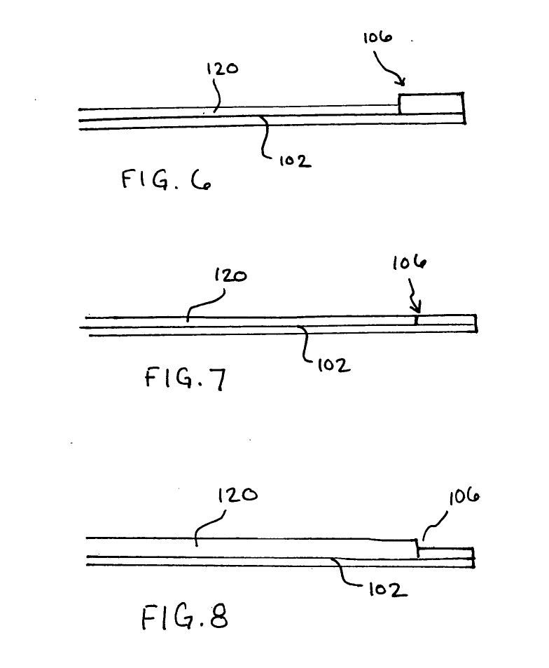

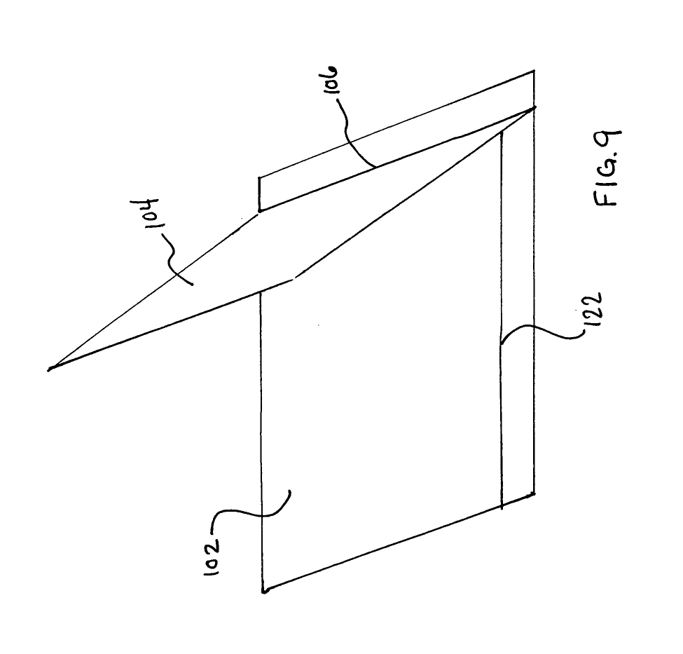

FIGS. 6-8 depict side views of portions of postcards having guides 106 with various thicknesses relative to the anticipated thickness of postcards 120 to be fastened thereto, in accordance with embodiments of the present invention. The first embodiment includes a guide 106 with a greater thickness than the anticipated thickness of a postcard 120 to be fastened thereto. The second embodiment includes a guide 106 having a guide with the same thickness as the anticipated thickness of a postcard 120 to be fastened thereto. The third embodiment includes a guide 106 with a lesser thickness than the anticipated thickness of a postcard 120 to be fastened thereto.

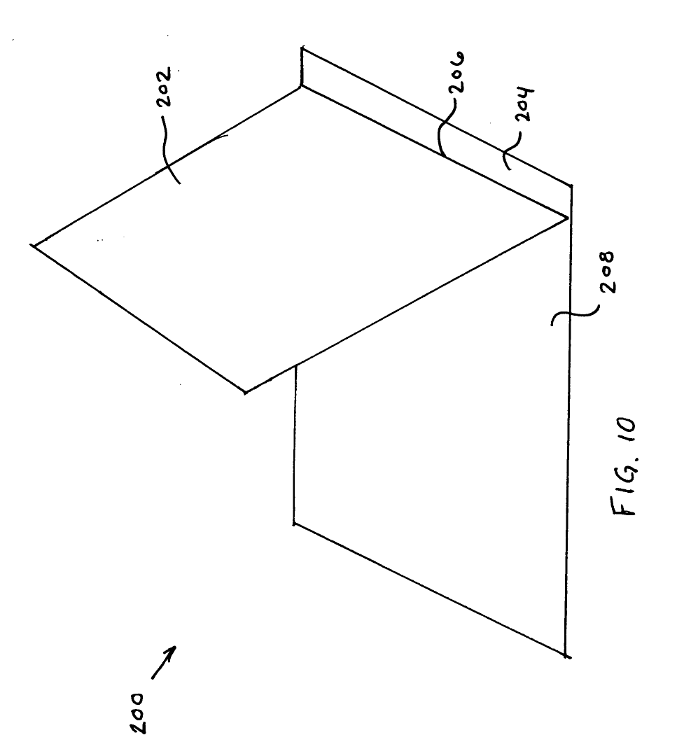

FIG. 9 depicts a perspective view of yet another alternate postcard having two guides rather than one, in accordance with an embodiment of the present invention. The postcard includes a hinged guide 106, as well as another guide 122 along a different edge of the fastening surface 102. The presence of the second guide 122 provides further aid to an individual in controllably placing and orienting a photograph for fastening to the fastening surface 102.

FIG. 10 depicts a perspective view of another alternate postcard, in accordance with an embodiment of the present invention. Postcard product 200 includes a postcard region 202 and a guide region 204 adjacent to each other forming a guide 206 along their line of adjacency. A first layer 208 is disposed beneath a second layer which includes the two regions 202 and 204. The inner surface (not shown) of the postcard region 202 comprises a fastening surface adapted to have a photograph fastened thereto. In use, the postcard region 202 would be detached from the guide region 204 after attaching the photograph to the fastening surface. Indicia for mailing would be placed (or pre-placed) on the postcard region surface opposite the fastening surface. The guide 206 may be defined by any mechanism (e.g., perforation, creasing, printed indicia, etc.) which defines the line of hinged association between postcard region 202 and guide region 204.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing embodiments of the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

The term “postcard,” as used herein, includes articles having any relatively flat shape (e.g., rectangular, square, oval, odd, etc.), of any thickness, of any size, of any material, with or without postage, and whether or not compliant with mailing requirements or regulations.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. For example, the adhesive fastening compound of the preferred embodiment could be of any suitable type, and could have special features which improve the performance of the postcard under select circumstances (e.g., pressure-activated adhesive which does not require protection by a paper release sheet, etc.). As another example, another embodiment of the present invention is configured for fastening more than one photograph thereto. As yet another example, the adhesive can be permanent or temporary. As a further example, the fastening surface itself can be adapted to fasten a photograph thereto (e.g., being inherently sticky, having a polymer composition for acting as “molecular-level Velcro,” etc.). Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A postcard comprising:
a fastening surface;
a guide disposed along an edge of the fastening surface;
wherein said guide is configured to limit, by contact and in at least one dimension, the orientation of a photograph relative. to the fastening surface.

2. The postcard of claim 1, further comprising:
an adhesive region disposed on the fastening surface for adhesively retaining such a photograph upon contact of a surface of the photograph with the adhesive region.

3. The postcard of claim 2, wherein the adhesive region is disposed on the fastening surface so as to leave a non-adhesive region adjacent to the guide.

4. The postcard of claim 2, wherein the adhesive region is disposed on the fastening surface so that a non-adhesive region is contained within the adhesive region.

5. The postcard of claim 2, further comprising at least one additional adhesive region disposed on the fastening surface.

6. The postcard of claim 5, wherein at least two of the adhesive regions are disposed on the fastening surface such that each is oriented along an opposite edge of the fastening surface.

7. The postcard of claim 2, further comprising:
a paper release sheet hingedly attached to the guide for protecting the adhesive region from unintended adhesion.

8. The postcard of claim 1, further comprising:
an additional guide disposed along another edge of the fastening surface.

9. A postcard product comprising:
a first layer;
a second layer disposed upon the first layer, wherein the second layer comprises:
a guide region oriented along an edge of the second layer, and
a postcard region adjacent to and hingedly connected to the guide region structurally forming a guide, wherein the postcard region includes a fastening surface between the second layer and the first layer;
whereby the guide is configured to assist an individual in selectively orienting a photograph between the hingedly open postcard region and the first layer, according to which an edge of the photograph can be placed in contact with the guide prior to fastening the photograph to the fastening surface.

10. The product of claim 9, further comprising:
an adhesive region disposed on the fastening surface for adhesively retaining the photograph upon contact of a surface of the photograph with the adhesive region.

11. The product of claim 10, wherein the adhesive region is disposed on the fastening surface so as to leave a non-adhesive region adjacent to the guide.

12. The product of claim 10, further comprising at least one additional adhesive region disposed on the fastening surface.

13. The product of claim 10, wherein the first layer comprises a paper release sheet for protecting the adhesive region from unintended adhesion.

14. The product of claim 9, wherein the second layer further comprises:
an additional guide region disposed along another edge of the second layer.

15. A method of manufacturing a postcard, including:
providing a cardstock having a fastening surface;
disposing, along an edge of the fastening surface, a guide;
whereby the guide is raised relative to the fastening surface for constraining lateral movement of a photograph, by contact and in at least one dimension.

16. The method of claim 15, further comprising:
disposing an adhesive compound upon the fastening surface such that at least one adhesive region is formed.

17. The method of claim 16, further comprising:
disposing a paper release sheet upon the adhesive region.

18. The method of claim 17, further comprising:
attaching at least one edge of the paper release sheet to the guide;
whereby the paper release sheet is hingedly attached to the guide.

19. The method of claim 15, further comprising:
disposing additional adhesive compound upon the fastening surface such that at least one additional adhesive region is formed.

20. The method of claim 15, further comprising:
disposing, along another edge of the fastening surface, an additional guide.
